(19) United States
(12) Patent Application Publication
(10) Pub. No.: US 2026/0118794 A1
(43) Pub. Date: Apr. 30, 2026

(54) IMAGE FORMING APPARATUS AND CHARGING DEVICE

(71) Applicant: Masayuki Kasukawa, Misato Saitama (JP)

(72) Inventor: Masayuki Kasukawa, Misato Saitama (JP)

(73) Assignee: ETRIA CO., LTD., Kanagawa (JP)

(21) Appl. No.: 19/272,172

(22) Filed: Jul. 17, 2025

(30) Foreign Application Priority Data
Oct. 28, 2024 (JP) 2024-189072

(51) Int. Cl. G03G 15/02; F16C 17/02; G03G 21/16

(52) U.S. Cl. CPC G03G 15/0216; F16C 17/02; G03G 21/1647

(57) ABSTRACT

An image forming apparatus according to an embodiment includes an image carrier, a charging roller, a casing and a bearing. The charging roller is in rotational contact with a surface of the image carrier to charge the surface. The casing cases the charging roller. The bearing is attached to the casing rotatably about a rotary shaft extending in a direction where the image carrier and the charging roller are aligned, to rotatably support a shaft of the charging roller.

### CROSS-REFERENCE TO RELATED APPLICATION

This application is based upon and claims the benefit of priority from prior Japanese Patent Application No. 2024-189072, filed Oct. 28, 2024, the entire contents of which are incorporated herein by reference.

### FIELD

Embodiments described herein relate generally to an image forming apparatus such as a copier and a printer, and a charging device of the image forming apparatus.

### BACKGROUND

An image forming apparatus such as a copier and a printer includes a charging device that charges the surface of a photoconductive drum to a predetermined potential, an exposure device that forms an electrostatic latent image on the surface of the photoconductive drum, a developing device that develops the electrostatic latent image by supplying toner therewith, a conveyance device that conveys paper to the surface of the photoconductive drum, a transfer device that transfers a toner image formed on the surface of the photoconductive drum to the paper, and a fixing device that fixes the toner image transferred to the paper.

The charging device includes, for example, a charging roller that is in rotational contact with the surface of the photoconductive drum and a cleaning roller that is in rotational contact with the surface of the charging roller. The charging device also includes, for example, two bearings that rotatably hold both ends of the shaft of the charging roller and both ends of the shaft of the cleaning roller, a casing that cases an assembly both ends of which are held by the two bearings, and a pressure spring that presses the two bearings toward the surface of the photoconductive drum. The two bearings are attached to the casing such that they can be moved toward the surface of the photoconductive drum. The pressure spring is interposed between the casing and the two bearings to press the two bearings toward the photoconductive drum.

The casing has approximately the same length as the photoconductive drum, and may be bent when molded with resin. When the casing is bent, the bearings attached to the casing are inclined with respect to the shaft of the charging roller, and the resistance of contact between the shaft and the bearings increases, with the result that the charging roller may not rotate normally. In this case, an undesirable load is applied to the photoconductive drum that is in contact with the charging roller, which adversely affects the image.

### BRIEF DESCRIPTION OF THE DRAWINGS

A general architecture that implements various features of the embodiments will now be described with reference to the drawings. The drawings and their associated descriptions are provided to illustrate the embodiments and not to limit the scope of the invention.

FIG. 1 is a schematic view showing an image forming apparatus according to an embodiment.

FIG. 2 is a schematic view showing a yellow image forming unit of the image forming apparatus of FIG. 1.

FIG. 3 is an exploded perspective view showing a charging device of the image forming unit of FIG. 2.

FIG. 4 is an enlarged perspective view of a bush on the rear side of the charging device of FIG. 3.

FIG. 5 is a perspective view of the bush of FIG. 4 when viewed from the direction of arrow F5.

FIG. 6 is a partially enlarged sectional view of a portion near the rear end of the charging device of FIG. 3.

FIG. 7 is a partially enlarged perspective view of a portion near the rear end of a casing shown in FIG. 6.

FIG. 8 is a partially enlarged plan view of the portion near the rear end of the charging device of FIG. 3.

FIG. 9 is an enlarged perspective view of a bush on the front side of the charging device of FIG. 3.

FIG. 10 is a plan view illustrating the functions of the charging device of FIG. 3.

FIG. 11 is a plan view illustrating the functions of the charging device of FIG. 3.

### DETAILED DESCRIPTION

An image forming apparatus according to an embodiment includes an image carrier, a charging roller, a casing and a bearing. The charging roller is in rotational contact with a surface of the image carrier to charge the surface. The casing cases the charging roller. The bearing is attached to the casing rotatably about a rotary shaft extending in a direction where the image carrier and the charging roller are aligned, to rotatably support a shaft of the charging roller.

An image forming apparatus 100 (referred to simply as apparatus 100 hereinafter) according to one embodiment will be described below with reference to the drawings. Note that in the drawings, the scale of each component therein may be changed as appropriate. Further, in the drawings, the structure of a component may not be shown in order to make the description easy to understand.

The apparatus 100 is, for example, a multifunction peripheral (MFP). The apparatus 100 has a printing function, a scanning function, a copying function, a color erasing function, a facsimile function, and the like. The printing function is a function of forming an image on paper P. The scanning function is a function of reading an image from a document or the like. The copying function is a function of printing the image, which is read from the document or the like using the scanning function, on the paper P by the printing function. The color erasing function is a function of erasing the color of an image formed on the paper P with a color-erasable toner.

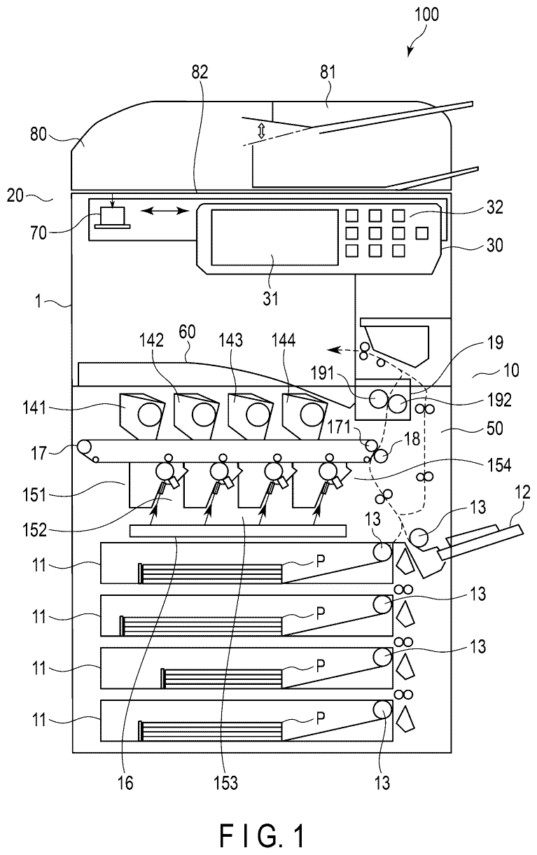

As shown in FIG. 1, the apparatus 100 includes a casing 1 that forms an outer shell of the apparatus. The apparatus 100 includes a printer 10, a scanner 20 and an operating panel 30. The printer 10 and scanner 20 are provided at the interior of the casing 1, and the operating panel 30 is provided on the front side of the casing 1. In the following description, the front and rear, up and down (vertical), and right and left (lateral) directions of all the components of the apparatus 1 are defined in the diagram of FIG. 1.

The printer 10 includes a plurality of paper feed cassettes 11, a manual paper feed tray 12 and a plurality of paper feed rollers 13. The paper feed cassettes 11 store paper P for use in printing. The manual paper feed tray 12 is one for manually feeding the paper P. The paper feed rollers 13 rotate to select either the paper feed cassettes 11 or the manual paper feed tray 12 to take out the paper P therefrom.

The printer 10 includes four toner cartridges 141 to 144, four image forming units 151 to 154, an exposure device 16, a transfer belt 17, a secondary transfer roller 18 and a fixing device 19.

The toner cartridges 141 to 144 each store toner that is to be supplied to the image forming units 151 to 154. The toner cartridge 141 stores yellow (Y) toner. The toner cartridge 142 stores magenta (M) color toner. The toner cartridge 143 stores cyan (C) color toner. The toner cartridge 144 stores black (K) color toner. The color combination of the toner is not limited to YMCK but may be any other color combination. In addition, the toner may be toner that erases color at a temperature higher than a predetermined temperature.

The image forming units 151 to 154 receive toner from the toner cartridge 141 to 144, respectively to form toner images of different colors. The image forming unit 151 forms a yellow (Y) color toner image. The image forming unit 152 forms a magenta (M) color toner image. The image forming unit 153 forms a cyan (C) color toner image. The image forming unit 154 forms a black (K) color toner image.

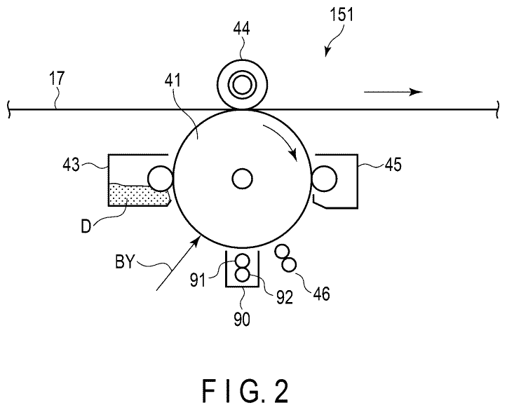

The image forming units 151 to 154 have the same configuration except to form toner images of different colors. Thus, the image forming unit 151 to form a yellow color toner will be described below with reference to FIG. 2, and the image forming units 152 to 154 to form toner images of the other colors will not be described.

The image forming unit 151 includes a photoconductive drum 41, a charging device 90, a developing device 43, a primary transfer roller 44, a cleaner 45 and a static elimination lamp 46. The charging device 90 faces the lower part of the photoconductive drum 41 in the gravitational direction.

The photoconductive drum 41 has a rotating shaft extending forward and backward of the apparatus 100. The photoconductive drum 41 has a surface that receives a light beam BY from the exposure device 16. The photoconductive drum 41 is an example of an image carrier. The charging device 90 charges the surface of the photoconductive drum 41 to a predetermined potential. The exposure device 16 forms an electrostatic latent image on the surface of the photoconductive drum 41. The developing device 43 develops the electrostatic latent image on the surface of the photoconductive drum 41 using yellow toner D supplied from the toner cartridge 141. That is, the developing device 43 forms a yellow toner image on the surface of the photoconductive drum 41.

The primary transfer roller 44 is opposed to the surface of the photoconductive drum 41 with the transfer belt 17 therebetween. The primary transfer roller 44 generates a transfer voltage with the photoconductive drum 41. Thus, the primary transfer roller 44 transfers the toner image on the surface of the photoconductive drum 41 to the surface of the transfer belt 17 that is in contact with the photoconductive drum 41 (primary transfer).

The cleaner 45 removes toner remaining on the surface of the photoconductive drum 41. The static elimination lamp 46 removes charges remaining on the surface of the photoconductive drum 41.

The exposure device 16 receives image data to irradiate the surfaces of the photoconductive drums 41 of the image forming units 151, 152, 153 and 154 with light beams BY, BM, BC and BK, respectively. The light beams BY, BM, BC and BK are based on image data of respective colors obtained by separating image data into Y, M, C and K colors.

The exposure device 16 emits the light beam BY in accordance with image data of Y component to form an electrostatic latent image for yellow on the surface of the photoconductive drum 41 of the image forming unit 151. Similarly, the exposure device 16 emits light beams BM, BC and BK in accordance with image data of M, C and K components to form electrostatic latent images for respective colors on the surfaces of the photoconductive drums 41 of the image forming units 152, 153 and 154.

Note that the image data input to the exposure device 16 is, for example, image data read from a document or the like by the scanner 20. Alternatively, the image data input to the exposure device 16 is image data transmitted to the apparatus 100 from an external apparatus different from the apparatus 100.

As shown in FIG. 1, the transfer belt 17 is extended endlessly, and is rotated by rotating a driving roller 171 on which the transfer belt 17 is wound. As the transfer belt 17 rotates, the toner images of respective colors superposed on the surface of the transfer belt 17 by the image forming units 151 to 154 are transferred to a transfer region opposed to the secondary transfer roller 18.

The secondary transfer roller 18 faces the driving roller 171 with the transfer belt 17 therebetween. The secondary transfer roller 18 transfers the toner image from the transfer belt 17 to the paper P that passes between the transfer belt 17 and the secondary transfer roller 18 (secondary transfer).

The fixing device 19 heats and pressurizes the paper P. The fixing device 19 includes a heating roller 191 and a pressurizing roller 192 which are opposed to each other with a conveying path of the paper P therebetween. The heating roller 191 includes a heat source such as a heater. The heating roller 191 heated by the heat source comes into contact with the paper P and heats the paper P. The pressurizing roller 192 pressurizes the paper P that passes between the pressurizing roller 192 and the heating roller 191. Thus, the fixing device 19 fixes the transferred toner image to the paper P.

The printer 10 further includes a double-sided unit 50 and a paper output tray 60. The double-sided unit 50 makes the paper P printable on the back surface. The double-sided unit 50 switches back the paper P to reverse the paper P and then send the paper P to the transfer region between the transfer belt 17 and the secondary transfer roller 18. The paper output tray 60 outputs the paper P on which an image has been printed.

The scanner 20 reads an image from a document or the like. The scanner 20 includes a reading module 70 and a document feeding device 80.

The reading module 70 applies illumination light to the surface of a document (hereinafter referred to as a document surface) having an image to be read, and its reflected light is received by an image sensor (not shown) and converted into a digital signal. Thus, the reading module 70 reads the image from the document surface.

The document feeding device 80 is, for example, an auto document feeder (ADF). The document feeding device 80 successively conveys the documents placed on a document tray 81 through a document glass 82. The reading module 70 reads images from the documents conveyed to the original glass 82. The document feeding device 80 may include another reading module for reading an image from the backside of a document.

The operating panel 30 is a man-machine interface that performs input and output operations between the apparatus 100 and its operator. The operating panel 30 includes, for example, a touch panel 31 and an input device 32.

The touch panel 31 is formed by laminating a display such as a liquid crystal display and an organic EL display and a touch-input pointing device. The display of the touch panel 31 displays a screen for notifying the operator of the apparatus 100 of various items of information. The touch panel 31 accepts a touch operation from the operator.

The input device 32 accepts an operation from the operator of the apparatus 100. The input device 32 is, for example, a keyboard, keypad and a touchpad.

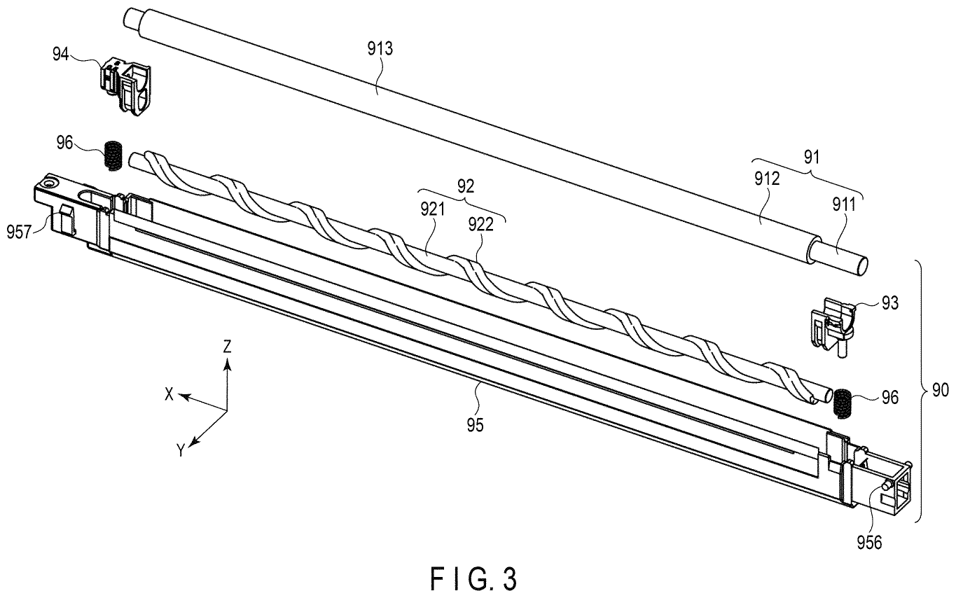

The above-described charging device 90 will be described below with reference to FIGS. 3 to 9.

In FIGS. 3 to 9, the direction from the rear to front of the apparatus 100 is indicated by arrow X, the direction from the the left to the right is indicated by arrow Y, and the direction from the bottom to the top is indicated by arrow Z. In the direction indicated by arrow Z, the photoconductive drum 41 and the charging roller 91 of the charging device 90 are aligned.

As shown in FIG. 3, the charging device 90 includes a cleaning roller 92, a rear bush 93, a front bush 94, a casing 95 and two pressure springs 96 in addition to the charging roller 91. The charging roller 91, cleaning roller 92 and casing 95 extend in the back-and-forth direction over substantially the entire length of the photoconductive drum 41. The rear bush 93 is an example of a bearing. The pressure springs 96 are an example of a pressure member. The pressure springs 96 push up the bushes 93 and 94 toward the photoconductive drum 41 located above the charging device 90 to press the charging roller 91 on the surface of the photoconductive drum 41.

The charging roller 91 includes a roller portion 912 coaxially on the outside of a shaft portion 911. The charging roller 91 is located below and in parallel to the photoconductive drum 41 so that the outer peripheral surface 913 of the roller portion 912 is brought into rotational contact with the surface of the photoconductive drum 41. The charging roller 91 is pressed on the surface of the photoconductive drum 41 by the energizing force of the two pressure springs 96. As the photoconductive drum 41 rotates, the charging roller 91 rotates together. If a voltage is applied to the charging roller 91, an electrical discharge occurs in a minute space between the charging roller 91 and the photoconductive drum 41 and thus the surface of the photoconductive drum 41 is charged to a predetermined potential.

The cleaning roller 92 includes a shaft portion 921 and a spiral portion 922 coaxially with each other. The spiral portion 922 is shaped by spirally winding an elastically deformable long member such as a sponge around the outer peripheral surface of the shaft portion 921. The spiral portion 922 has a rectangular section that is orthogonal to the direction along the spiral. The spiral portion 922 has an inner surface in which one side of the rectangular section is continuous in the direction along the spiral and an outer surface opposed to the inner surface. The inner surface of the spiral portion 922 is fixed to the outer peripheral surface of the shaft portion 921, and the outer surface thereof is brought into contact with the outer peripheral surface 913 of the roller portion 912 of the charging roller 91.

The cleaning roller 92 is located below and in parallel with the charging roller 91 such that the spiral portion 922 is partially crushed and pressed on the roller portion 912 of the charging roller 91. The shaft portion 921 of the cleaning roller 92 is parallel to the shaft portion 911 of the charging roller 91. As the charging roller 91 rotates, the cleaning roller 92 rotates together. The cleaning roller 92 removes toner on the outer peripheral surface 913 of the roller portion 912 of the charging roller 91.

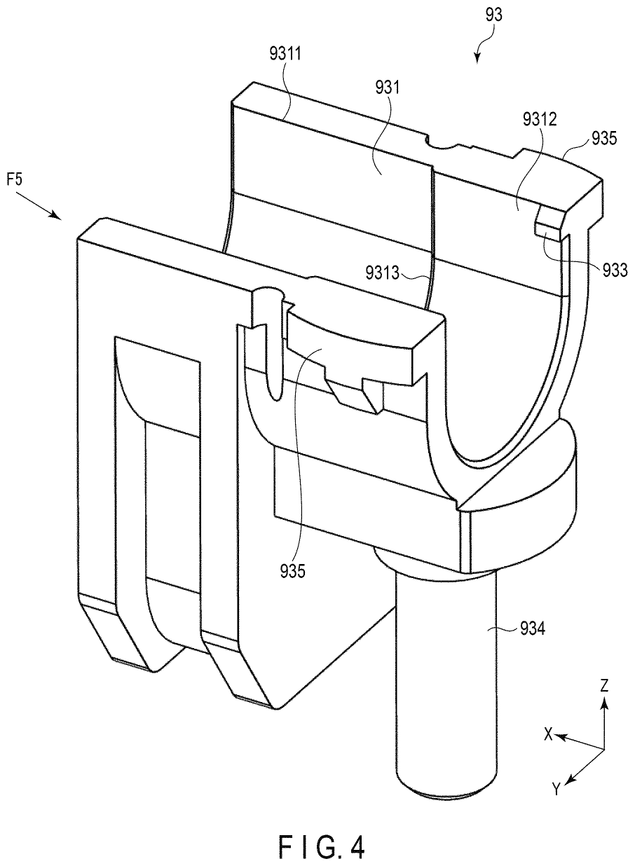

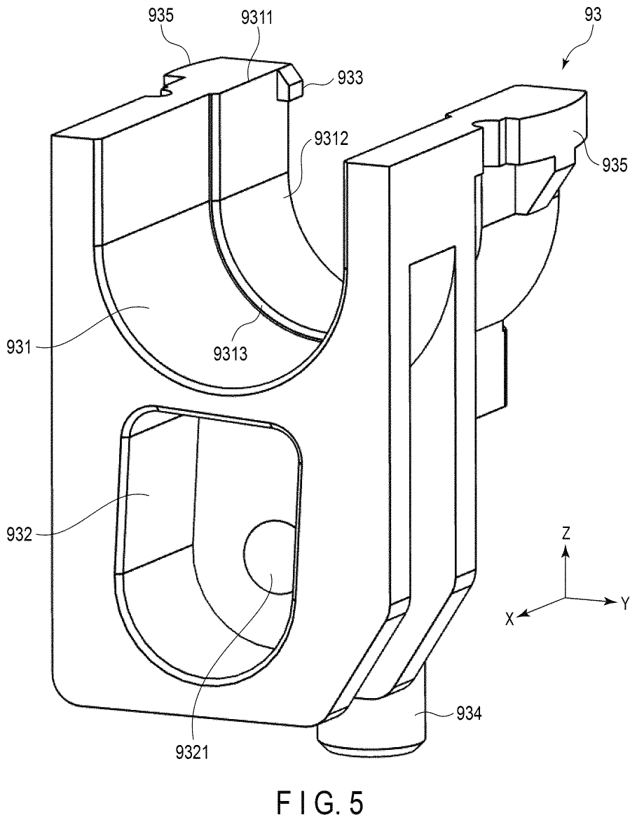

As shown in FIGS. 4 and 5, the rear bush 93 has a bearing groove 931 and a bearing hole 932. The bearing groove 931 rotatably receives the rear end of the shaft portion 911 of the charging roller 91. The bearing hole 932 rotatably receives the rear end of the shaft portion 921 of the cleaning roller 92. The bearing groove 931 and the bearing hole 932 are so located that the spiral portion 922 of the cleaning roller 92 in which the shaft portion 921 is received in the bearing hole 932 is pressed on the outer peripheral surface 913 of the roller portion 912 of the charging roller 91 in which the shaft portion 911 is received in the bearing groove 931. The bearing groove 931 and the bearing hole 932 extend in parallel to each other.

The bearing groove 931 has an inner surface having a U-shaped section in a plane parallel to the YZ plane that is orthogonal to the axial direction (back-and-forth direction). Both ends of the bearing groove 931 in its back-and-forth direction are open. The bearing groove 931 has in its upper part a substantially rectangular opening 9311 which can receive the shaft portion 911 of the charging roller 91 from above. The bearing groove 931 has on its rear inner surface a belt-shaped bearing projection 9312 that slides in contact with the outer peripheral surface of the shaft portion 911 of the charging roller 91. The inner surface of the bearing projection 9312 has a cylindrical surface whose curvature is substantially the same as that of the outer peripheral surface of the shaft portion 911. The width between the inner surfaces of the bearing projections 9312 on both sides of the opening 9311 in its lateral direction is slightly larger than the diameter of the shaft portion 911. The front inner surface of the bearing groove 931 is opposed to the circumferential surface of the shaft portion 911 with a slight gap therebetween. That is, the inner surface of the bearing groove 931 has a step 9313 somewhere in the shaft direction.

The bush 93 has a claw portion 933 integrally projected inward from near the left edge of the opening 9311 close to the rear end of the bearing groove 931. The distance between the tip of the claw portion 933 in the projecting direction and the edge of the opposite opening 9311 is slightly smaller than the diameter of the shaft portion 911 of the charging roller 91. The claw portion 933 prevents the shaft portion 911 located in the bearing groove 931 from coming out upwardly. When the shaft portion 911 is inserted in the bearing groove 931, for example, the shaft portion 911 is inserted into the bearing groove 931 through the opening 9311 at a position away from the front of the claw portion 933, and the shaft portion 911 is slightly slid toward the rear with respect to the bearing groove 931 so that the rear end of the shaft portion 911 is located below the claw portion 933.

As described above, the shaft portion 911 is inserted in the bearing groove 931, the outer peripheral surface near the rear end of the shaft portion 911 of the charging roller 91 is in contact with the inner surface of the bearing projection 9312 of the bearing groove 931, and the shaft portion 911 can rotate coaxially with respect to the bearing groove 931. Since, furthermore, the inner surface of the bearing projection 9312 of the bearing groove 931 has substantially the same curvature as that of the shaft portion 911, the lateral movement of the shaft portion 911 with respect to the bearing groove 931 is restricted. Note that since the upper part of the bearing groove 931 is opened toward the photoconductive drum 41, the shaft portion 911 can move slightly upward relative to the bearing groove 931 until it is brought into contact with the claw portion 933.

The bearing hole 932 is located below the bearing groove 931 at a position away from the front of the bearing projection 9312 of the bearing groove 931. The rear end of the bearing hole 932 is closed in front of the bearing projection 9312 of the bearing groove 931. On the front surface of the rear bottom of the bearing hole 932, there is a projection 9321 having a spherical surface slightly expanded on the front side. The rear end of the shaft portion 921 of the cleaning roller 92 inserted into the bearing hole 932 can abut against the top of the projection 9321 on the bottom surface of the bearing hole 932. The section of the bearing hole 932 which is parallel to the YZ plane is substantially U-shaped, the width of the bearing hole 932 in the lateral direction is slightly larger than the diameter of the shaft portion 921 of the cleaning roller 92, and the shaft portion 921 inserted into the bearing hole 932 is restricted in the lateral direction relative to the bush 93 and can move slightly upward toward the charging roller 91.

The bush 93 is provided integrally with a cylindrical rotary shaft 934 below the bearing projection 9312 of the bearing groove 931. The rotary shaft 934 has a central axis extending in the vertical direction orthogonal to the bearing groove 931 and the bearing hole 932. The rotary shaft 934 is located at a position where its central axis intersects the center of the shaft portion 911 of the charging roller 91 which is received in the bearing groove 931.

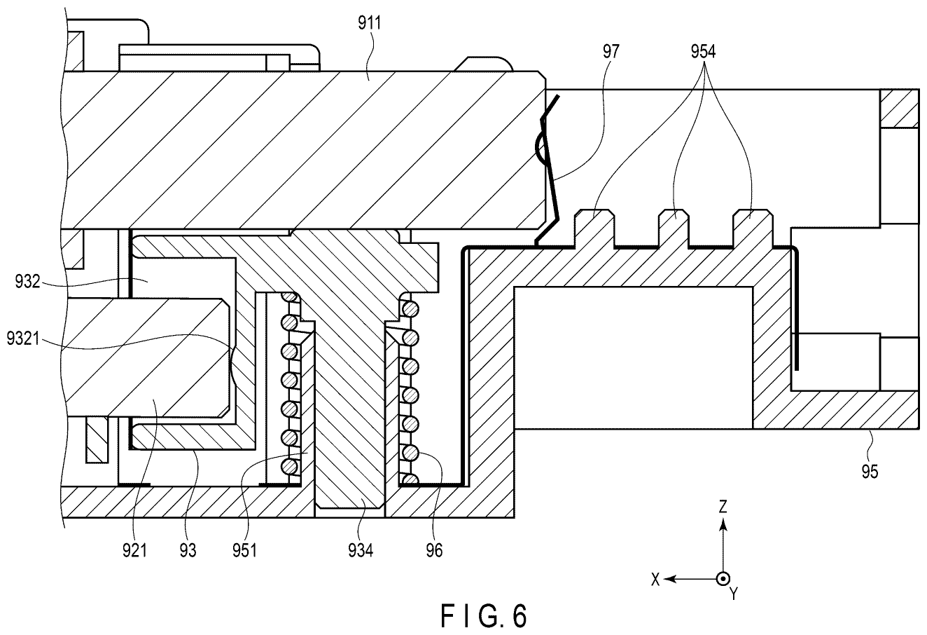

As shown in FIG. 6, the bush 93 can be attached to the casing 95 by inserting the rotary shaft 934 into a cylindrical sleeve 951 of the casing 95. The inner diameter of the sleeve 951 is slightly larger than the outer diameter of the rotary shaft 934. The sleeve 951 has a hole through which the rotary shaft 934 is inserted rotatably and slidably in the vertical direction. It is desirable that the sleeve 951 be as long as possible in order to prevent the rotary shaft 934 of the bush 93 from inclining. The hole of the sleeve 951 extends vertically and penetrates the bottom surface of the casing 95.

To attach the bush 93 to the casing 95, the foregoing pressure springs 96 are coaxially attached to the outside of the sleeve 951 of the casing 95, and the rotary shaft 934 of the bush 93 is inserted into the sleeve 951 while the pressure springs 96 are pressed and contracted. In this state, the pressure springs 96 press the bush 93 upward along the rotary shaft 934 by its restoring force. The bush 93 is rotatable about the rotary shaft 934 with respect to the casing 95, and is vertically movable along the rotary shaft 934 with respect to the casing 95.

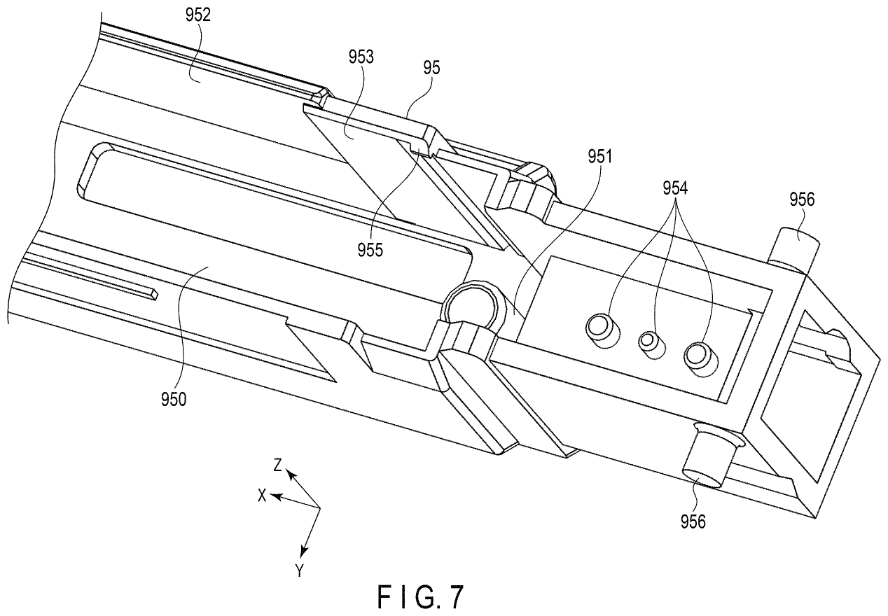

As shown in FIG. 7, the casing 95 includes a housing 950 that houses an assembly of the charging roller 91, cleaning roller 92 and two bushes 93 and 94. In the assembly, as described above, the rear end of the shaft portion 911 of the charging roller 91 and the rear end of the shaft portion 921 of the cleaning roller 92 are held by the bush 93, and the front ends of the two shaft portions 911 and 921 are held by the bush 94 on the front side. The housing 950 has a substantially rectangular opening 952 that is long in the back-and-forth direction for inserting the assembly from above the casing 95.

The rear bush 93 is attached to the housing 950 near the rear end of the casing 95 via the opening 952. As described above, the rear bush 93 can be attached to the rear side of the housing 950 by inserting the rotary shaft 934 into the sleeve 951 protruding from the bottom of the housing 950. The front bushing 94 is attached to the housing 950 near the front end of the casing 95 via the opening 952.

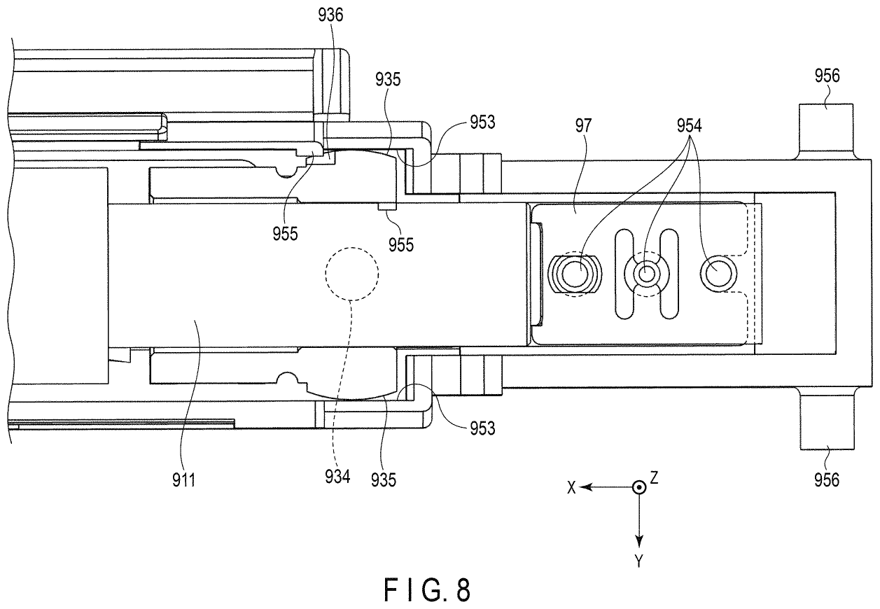

As shown in FIG. 8, the rear bush 93 has column surfaces 935 that are coaxial with the rotary shaft 934 on both sides in the lateral direction. The column surfaces 935 are concentric curved surfaces formed by rotating a line parallel to the rotary shaft 934 about the rotary shaft 934. The casing 95 has sliding contact surfaces 953 that are in sliding contact with the column surfaces 935 of the bush 93 on the inner surfaces of the right and left sides of the housing 950. The two right and left sliding contact surfaces 953 are, for example, flat surfaces parallel to the XZ plane. The distance between the two sliding contact surfaces 953 in the lateral direction is slightly larger than the distance between the tops of the two right and left column surfaces 935 of the bush 93 which are most spaced in the lateral direction. The sliding contact surfaces 953 allow the bush 93 to rotate with respect to the casing 95, and prevent the bush 93 from moving (inclining) in the lateral direction with respect to the casing 95. The sliding contact surfaces 953 are not limited to planes, and may be, for example, curved surfaces whose curvature is smaller than that of the column surfaces 935 of the bush 93.

The bush 93 includes neither a slide groove nor a slide rail which is movably attached to the casing 95 in the vertical direction, and the casing 95 includes neither a slide groove nor a slide rail for movably attaching the bush 93 in the vertical direction. The bush 93 is movable vertically relative to the casing 95 by sliding the rotary shaft 934 vertically relative to the sleeve 951, and is rotatable relative to the casing 95 around the rotary shaft 934. The sliding contact surfaces 953 of the column surfaces 935 of the bush 93 and the casing 95 prevent the bush 93 from falling in the lateral direction with respect to the casing 95 and guide the rotation of the bush 93 with respect to the casing 95.

As shown in FIG. 8, the bush 93 includes an engaging step 936 near the left column surface 935 to prevent the bush 93 from coming upward out of the housing 950. The casing 95 includes an engagement claw 955 which is opposed to and slightly spaced above the engagement step 936 while the bush 93 is held in the housing 950. If the bush 93 is attached to the housing 950 through the opening 952, the engaging step 936 of the bush 93 gets over the engaging claw 955 of the casing 95 with deformation of the engaging claw 955, and the engaging step 936 is opposed to the lower side of the engaging claw 955. In this state, the bush 93 can be prevented from coming upward out of the casing 95. Note that the engaging step 936 and the engaging claw 955 are shaped and located to allow the bush 93 to slightly rotate and slightly move vertically relative to the casing 95.

As shown in FIGS. 6 and 8, the casing 95 includes a leaf spring 97 that presses the rear end of the shaft portion 911 of the charging roller 91 toward the front end thereof. The leaf spring 97 is an example of a pressure member. The casing 95 includes three bosses 954 for fixing the leaf spring 97 on the rear side of the sleeve 951 through which the rotary shaft 934 of the bush 93 is inserted. The leaf spring 97 is located to push toward the front side the end of the shaft portion 911 of the charging roller 91 which projects toward the rear of the bearing groove 931 of the bush 93 attached to the housing 950. The leaf spring 97 may have any shape and may be replaced with another pressure member such as a coil spring.

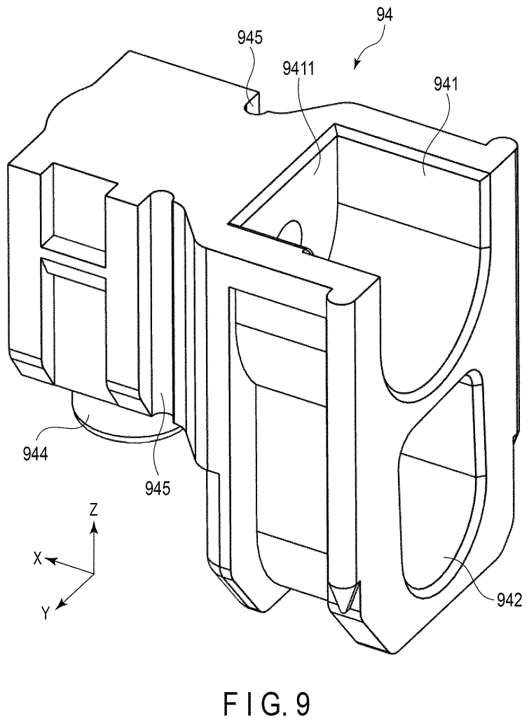

As shown in FIG. 9, the front bush 94 has a bearing groove 941 that rotatably receives the front end of the shaft portion 911 of the charging roller 91 and a bearing hole 942 that rotatably receives the front end of the shaft portion 921 of the cleaning roller 92. The front end of the bearing groove 941 is closed by an end wall 9411. The bearing hole 942 is a bottomed hole whose front end is closed. The bearing groove 941 is opposed to the front of the bearing groove 931 of the rear bush 93, and the bearing hole 942 is opposed to the front of the bearing hole 932 of the rear bush 93. The function of the bush 94 is essentially the same as that of the rear bush 93.

The front bush 94 has a boss 944 for attaching the upper end of each of the pressure springs 96 at a position corresponding to the rotary shaft 934 of the rear bush 93. The boss 944 is a cylindrical projection centered on an axis along the vertical direction. The boss 944 is located in a direction orthogonal to the bearing groove 941 and the bearing hole 942. The central axis of the boss 944 intersects the center of the shaft portion 911 of the charging roller 91 received in the bearing groove 941. The pressure spring 96 fixes its lower end to the bottom of the casing 95. The pressure spring 96 is pressed and contracted between the bottom of the casing 95 and the boss of the bush 94.

On the outer surface of the bush 94 in its lateral direction, there are two sliding grooves 945 extending in the vertical direction. The two sliding grooves 945 are opposed to each other in the lateral direction. The casing 95 includes two rails (not shown) on the right and left sides of the housing 950 at a position where the bush 94 is attached to the housing 950. When the bush 94 is attached to the housing 950, the two rails extend in the vertical direction at positions where they are respectively fit into the two sliding grooves 945 of the bush 94. The bush 94 is movable relative to the casing 95 in the vertical direction along the sliding grooves 945.

The pressure springs 96 contracted between the casing 95 and the bush 94 each place a force point on a straight line passing through its center and presses the bush 94 upward. The bush 94 is pushed up in the direction of the slide grooves 945 by the pressure springs 96 to push up the front end of the shaft portion 911 of the charging roller 91 and that of the shaft portion 921 of the cleaning roller 92. Accordingly, the front side of the charging roller 91 is pressed on the photosensitive drum 41.

As shown in FIGS. 7 and 8, the casing 95 includes two engagement pins 956 near the rear end thereof. The rear end of the casing 95 is a free end. The two engagement pins 956 project outward from the lateral outer surface of the casing 95 toward its outward distant directions and are arranged coaxially with each other. A frame (not shown) to which the photoconductive drum 41 is rotatably attached has two grooves (not shown) into which the two engagement pins 956 on the rear side of the casing 95 of the charging device 90 are respectively engaged. The grooves of the frame are located below the photoconductive drum 41 near the rear end of the photoconductive drum 41 and extend in the front and back direction at positions where they are opposed to each other in the lateral direction, and the rear ends thereof are opened. If the rear end of the casing 95 is fit into the grooves of the frame, the engagement pins 956 of the casing 95 are inserted into the grooves from the rear sides of the grooves, and the two engagement pins 956 are fit into the grooves of the frame. Therefore, the rear end of the casing 95 is slightly movable in the front and back direction along the grooves.

As shown in FIG. 3, the casing 95 includes two engagement claws 957 near the front end thereof. The front end of the casing 95 is a fixed end. The engagement claws 957 project outward from the lateral outer surface of the casing 95. The frame (not shown) to which the photoconductive drum 41 is attached has a step (not shown) for engaging the two engagement claws 957 of the casing 95. To attach the front end of the casing 95 to the frame, the casing 95 in which the two engagement pins 956 at the rear end are hooked to the grooves of the frame is rotated around the two engagement pins 956 in a direction approaching the photoconductive drum 41, and the engagement claws 957 are engaged with the step of the frame with the elastic deformation of the two engagement claws 957. In this state, a portion (not shown) of the casing 95 on its front side is fastened and fixed to the frame of the photoconductive drum 41 by a screw (not shown).

Note that the grooves and step (neither of which is shown) of the frame to which the photoconductive drum 41 is attached are located in a position where the outer peripheral surface 913 of the charging roller 91 is pressed on the surface of the photoconductive drum 41 while the rear side of the casing 95 is hooked to the grooves of the frame and the front side thereof is fixed to the frame.

Next is a description of the functions of the charging device 90 described above.

If the long casing 95 of the charging device 90 is molded by resin, it is bent more easily than the charging roller 91 and cleaning roller 92 having metal shaft portions 911 and 921. As the casing 95 is bent and curved, it is conceivable that an undesired stress may be exerted on the bushes 93 and 94 attached to both ends of the casing 95 in its longitudinal direction.

If the bending direction of the casing 95 is the vertical direction, the bushes 93 and 94 are inclined in the direction of the openings of the bearing grooves 931 and 941, with the result that a contact-resistance load is hardly applied to the shaft portion 911 of the charging roller 91. On the other hand, if the casing 95 is bent and curved in its lateral direction, a stress is applied thereto in a direction where the shaft portion 911 of the charging roller 91, which is difficult to bend, is cut into the inner surfaces of the bearing grooves 931 and 941 of the bushes 93 and 94 in their lateral direction.

If in the present embodiment, for example, the rear bush 93 is not rotatably attached to the casing 95 with the rotary shaft 934 centered, but the front bush 94 is slidably attached to the casing 95 by the sliding grooves and rail only in the vertical direction, the bushes 93 and 94 are inclined in the lateral direction with respect to the shaft portion 911 of the charging roller 91 due to the bending of the casing 95 in the lateral direction. In this case, only a slight inclination of the bushes 93 and 94 with respect to the shaft portion 911 causes the shaft portion 911 to be cut into the inner surfaces of the bearing grooves 931 and 941, thereby generating contact resistance between them.

As described above, in the present embodiment, the rear bush 93 is attached to the casing 95 rotatably around the rotary shaft 934. Thus, even though the casing 95 is bent in the lateral direction, the bush 93 can rotate in the lateral direction with respect to the casing 95, and the shaft portion 911 of the charging roller 91 and the bearing groove 931 of the bushing 93 can always be arranged straight. According to the present embodiment, therefore, even if the casing 95 is distorted in the lateral direction, it is possible to prevent a drawback in which an undesired stress is applied to the shaft portion 911 of the charging roller 91 from the bush 93, and it is possible to rotate the charging roller 91 normally.

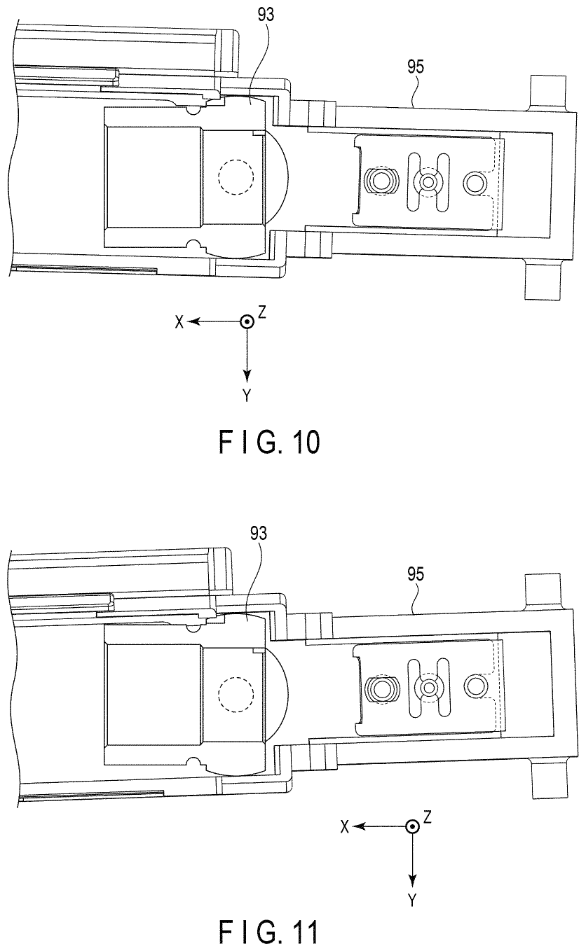

If the casing 95 is curved in a direction where the center of the casing 95 in the back-and-forth direction swells to the left as shown in, for example, FIG. 10, the rear end of the casing 95 whose front end is fixed to the frame of the photoconductive drum 41 is slightly inclined toward the right direction (downward in the figure). In this case, the casing 95 is slightly rotated in the clockwise direction (shown) around the rotary shaft 934 with respect to the bush 93 which supports the rear side of the shaft portion 911 of the charging roller 91, with the result that a drawback in which an undesired stress is applied to the bush 93 can be suppressed.

In addition, if the casing 95 is bent in a direction where the center of the casing 95 in the back-and-forth direction swells to the right as shown in, for example, FIG. 11, the rear end of the casing 95 whose front end is fixed to the frame of the photoconductive drum 41 is slightly inclined toward the left direction (upward in the figure). In this case, the casing 95 is slightly rotated in the counterclockwise direction (shown) about the rotary shaft 934 with respect to the bush 93 which supports the rear side of the shaft portion 911 of the charging roller 91, with the result that a drawback in which an desired stress is applied to the bush 93 can be suppressed.

As described above, according to the present embodiment, even though the casing 95 of the charging device 90 is bent, an undesired stress can be prevented from being applied to the shaft portion 911 of the charging roller 91, the charging roller 91 can always be rotated normally, and image defects can be prevented from occurring without applying an unnecessary load to the photoconductive drum 41.

In addition, according to the present embodiment, no undesirable stress is applied to the charging roller 91 even though the casing 95 is bent. Thus, a backlash between the bearing grooves 931 and 941 of the bushes 93 and 94 and the shaft portion 911 of the charging roller 91 can be lessened, and the positioning accuracy of the charging roller 91 with respect to the photoconductive drum 41 can be improved.

In addition, according to the present embodiment, the pressure spring 96 that energizes the rear bush 93 toward the photoconductive drum 41 is coaxially attached to the outside of the sleeve 951 of the casing 95 in which the rotary shaft 934 of the bush 93 is rotatably inserted. Thus, the central axis of the charging roller 91 can be located on the center line of the pressure spring 96, and the charging roller 91 can be pushed up straight toward the photoconductive drum 41.

In addition, according to the present embodiment, the pressure spring 96 is annularly attached to the outside of the sleeve 951 that supporting the rotary shaft 934 of the rear bush 93 rotatably and slidably. Thus, neither a sliding groove nor a rail for slidably supporting the bush 93 vertically is required, and a boss for holding the upper end of the pressure spring 96 can be used as the rotary shaft 934, thereby simplifying the configuration.

In addition, according to the present embodiment, the rear bush 93 has, in addition to the rotary shaft 934, a column surface 935 that is in slidable contact with the sliding contact surface 953 of the casing 95. It is thus possible to suppress the falling of the bush 93 in the lateral direction at a position separated above the rotary shaft 934, to rotate the bush 93 in a straight posture, and to suppress the generation of an undesired stress.

In addition, according to the present embodiment, the bush 93 that can be rotated with respect to the casing 95 is provided at a free end (i.e., the rear side) opposed to the fixed end of the casing 95 fixed to the frame that supports the photoconductive drum 41. Thus, positional accuracy of the charging roller 91 with respect to the photosensitive drum 41 via the casing 95 and the bush 94 is ensured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrier;
a charging roller that is in rotational contact with a surface of the image carrier to charge the surface;
a casing which cases the charging roller; and
a bearing which is attached to the casing rotatably about a rotary shaft extending in a direction where the image carrier and the charging roller are aligned, to rotatably support a shaft of the charging roller.

2. The image forming apparatus of claim 1, further comprising a pressure member which energizes the charging roller in the direction where the image carrier and the charging roller are aligned, to press the charging roller on the surface of the image carrier.

3. The image forming apparatus of claim 2, wherein the pressure member includes a pressure spring located coaxially with the rotary shaft between the casing and the bearing.

4. The image forming apparatus of claim 3, wherein:
the bearing includes the rotary shaft; and
the casing includes a sleeve through which the rotary shaft is rotatably inserted.

5. The image forming apparatus of claim 4, wherein the sleeve has a hole which penetrates the casing.

6. The image forming apparatus of claim 4, wherein the pressure spring is coaxially attached to an outside of the sleeve.

7. The image forming apparatus of claim 1, wherein:
the bearing has a column surface formed by rotating a line parallel to the rotary shaft about the rotary shaft; and
the casing has a sliding contact surface that is in slidable contact with the column surface.

8. The image forming apparatus of claim 1, wherein:
the casing has a fixed end that is positioned and fixed to the image carrier and a free end that is opposite to the fixed end along the shaft of the charging roller; and
the bearing is attached to the free end of the casing.

9. The image forming apparatus of claim 8, wherein:
the bearing has a groove which is opened toward the image carrier to receive the shaft of the charging roller; and
the casing includes a pressure member which presses the shaft received in the groove toward the fixed end in an axial direction.

10. The image forming apparatus of claim 9, wherein an end of the groove, which is on a side of the pressure member, is open.

11. A charging device comprising:
a charging roller that is in rotational contact with a surface of an image carrier to charge the surface;
a casing which cases the charging roller; and
a bearing which is attached to the casing rotatably about a rotary shaft extending in a direction where the image carrier and the charging roller are aligned, to rotatably support a shaft of the charging roller.

12. The charging device of claim 11, further comprising a pressure member which energizes the charging roller in the direction where the image carrier and the charging roller are aligned, to press the charging roller on the surface of the image carrier.

13. The charging device of claim 12, wherein the pressure member includes a pressure spring located coaxially with the rotary shaft between the casing and the bearing.

14. The charging device of claim 13, wherein:
the bearing includes the rotary shaft; and
the casing includes a sleeve through which the rotary shaft is rotatably inserted.

15. The charging device of claim 14, wherein the sleeve has a hole which penetrates the casing.

16. The charging device of claim 14, wherein the pressure spring is coaxially attached to an outside of the sleeve.

17. The charging device of claim 11, wherein:
the bearing has a column surface formed by rotating a line parallel to the rotary shaft about the rotary shaft; and
the casing has a sliding contact surface that is in slidable contact with the column surface.

18. The charging device of claim 11, wherein:
the casing has a fixed end that is positioned and fixed to the image carrier and a free end that is opposite to the fixed end along the shaft of the charging roller; and
the bearing is attached to the free end of the casing.

19. The charging device of claim 18, wherein:
the bearing has a groove which is opened toward the image carrier to receive the shaft of the charging roller; and
the casing includes a pressure member which presses the shaft received in the groove toward the fixed end in an axial direction.

20. The charging device of claim 19, wherein an end of the groove, which is on a side of the pressure member, is open.
